(19) United States
(12) Patent Application Publication
(10) Pub. No.: US 2016/0349448 A1
(43) Pub. Date: Dec. 1, 2016

(54) SYSTEM AND METHOD FOR MULTI-MODE OPTICAL FIBER

(71) Applicant: BEAM Photonic Technologies, Inc., The Woodlands, TX (US)

(72) Inventors: Antonius Marcellus Jozef (Ton) Koonen, Noord-Brabant (NL); Chigo M. Okonkwo, Noord-Brabant (NL)

(21) Appl. No.: 15/148,542

(22) Filed: May 6, 2016

Related U.S. Application Data
(60) Provisional application No. 62/327,981, filed on Apr. 26, 2016.
(60) Provisional application No. 62/327,977, filed on Apr. 26, 2016.

(30) Foreign Application Priority Data
May 29, 2015 (AU) 2015901995

(51) Int. Cl. G02B 6/028; G02B 6/02

(52) U.S. Cl. CPC G02B 6/0288; G02B 6/02042; G02B 6/02219

(57) ABSTRACT

A multi-mode optical fiber includes alternating cores have positive and negative differential mode delays over a range of wavelengths.

### REFERENCE TO RELATED APPLICATIONS

This application claims the benefit of U.S. Provisional Patent Application No. 62/327,981 filed Apr. 26, 2016, and also claims the benefit of U.S. Provisional Patent Application No. 62/327,977 filed Apr. 26, 2016, and also claims the benefit of Australian Provisional Application No. 2015901995 filed May 29, 2015, all of which are herein incorporated by reference.

This application is related to copending U.S. application Ser. No. 15/148,502 filed May 6, 2016, titled, “SYSTEM AND METHOD FOR PHOTONIC DETECTION AND EXCITATION OF MULTIPLE FIBRE MODES”.

### TECHNICAL FIELD

The subject application teaches embodiments that relate generally to an optical fiber for mode division multiplexing, and specifically to a multi-mode optical fiber with alternative cores having positive and negative differential mode delays.

### SUMMARY

In an example embodiment, a method includes alternating a first core portion with a second core portion to form an optical fiber, where the optical fiber has a plurality of alternating first and second core portions. The first core portion has a positive differential mode delay over a given range of wavelengths, and the second core portion has a negative differential mode delay over the range of wavelengths.

In an example embodiment, a multi-mode optical fiber is configured for use over a range of wavelengths includes a first core portion having a positive differential mode delay, and a second core portion having a negative differential mode delay. The first core portion and second core portion are configured in an alternating arrangement in the multi-mode optical fiber.

### BACKGROUND

With the persistent growth in Internet driven traffic, the backbone of our information driven society is approaching its fundamental capacity limits. Single Mode Fibre (SMF) data transmission is the most used type of data transmission in communication systems today. A single-mode fiber (SMF) by its very nature guides only one mode of light. Experts around the world have predicted that very soon SMFs will reach their theoretical transmission capacity limits such as the non-linear Shannon limits.

### BRIEF DESCRIPTION OF THE DRAWINGS

FIG. 1 is a diagram of a sectional view of a heated silica tube to form a multicore glass optical fibre according to an embodiment of the disclosure.

FIG. 2 is a diagram of a fused bi-tapered bundle of six multimode fibres and one low-mode fibre according to an embodiment of the disclosure.

FIG. 3 is a perspective side view of a system for determining the three dimensional (3D) shape and end position of an optical fibre according to an embodiment of the disclosure.

FIG. 4 is a chart of phase characteristics of the fibre modes versus the normalised frequency V according to an embodiment of the disclosure.

FIG. 5 is a diagram of a fibre graded index profile design according to an embodiment of the disclosure.

FIG. 6 is a diagram of characteristics of the differential mode delay between the LP₀₁ and LP₁₁ modes for different index profile parameters according to an embodiment of the disclosure.

FIG. 7 is a diagram of multi core fibres with alternating differential mode delay values in the N outer cores according to an embodiment of the disclosure.

FIG. 8 is a diagram of differential mode delay compensation or mitigation by concatenating multi core fibres with N outer cores and alternating differential mode delay of successive cores, by rotating the joints over an angle of 360°/N according to an embodiment of the disclosure.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein permit substantially synchronous (or synchronous) transmission of multiple modes of light, in one or two polarizations, in a multimode fibre. Although the disclosed system and method are described below with regard to multimode fibre, the system and method can be used with any suitable fiber as would be understood in the art.

In an embodiment, the system and method comprises but is not limited to the structures and functions of a Three Dimensional (3-D) Mode Multiplexing Chip. An example 3-D Mode Multiplexing Chip is disclosed in co-pending U.S. application Ser. No. 15/148,502 filed May 6, 2016, titled, “SYSTEM AND METHOD FOR PHOTONIC DETECTION AND EXCITATION OF MULTIPLE FIBRE MODES”.

In an embodiment, systems and methods of the present disclosure manage or substantially synchronize differing speeds of light when multiple modes of light are propagated from a single mode of light by a 3-D Mode Multiplexing Chip.

In an embodiment, the single mode of light guided through SMFs can be used in two orthogonal (i.e., with the electrical fields oriented at a 90° angle with respect to each other) polarization states, thereby providing two independent channels. Further, all the available dimensions for multiplexing of data for transmission through a single fibre core like the time domain, signal quadrature modulation domain, frequency domain and wavelength domain have been exploited near to exhaustion in order to extend the transport capacity of SMFs.

In the time domain, symbol rates are reaching the limits of current electronics (set by heat dissipation, footprint and performance) while in the wavelength domain signal bandwidths are hitting the limits of dense optical spectrum packing in spite of the International Telecommunications Union (ITU) having relaxed channel spacing requirement for Wavelength Division Multiplexing (WDM).

In the present disclosure, a new domain is opened in order to surmount the impending congestion in the presently deployed domains within a single optical fibre. The dimension of space is exploited. There are several options for utilizing the dimension of space to enhance fiber capacity including Multi Core Fibres (MCF), Multi Mode Fibres (MMF) and Multi-Mode Multi-Core Fibres (MM-MCF).

In MCFs, multiple light-guiding cores are hosted within a single fibre. One application of multi-core fibre is explained in Patent No. US006611648B2, where at least two cores out of a plurality of cores have different associated mean propagation constants calculated at a reference wavelength. The difference between the associated mean propagation constants may be selected to reduce cross-talk between at least two cores as compared to cores having the same associated mean propagation constant.

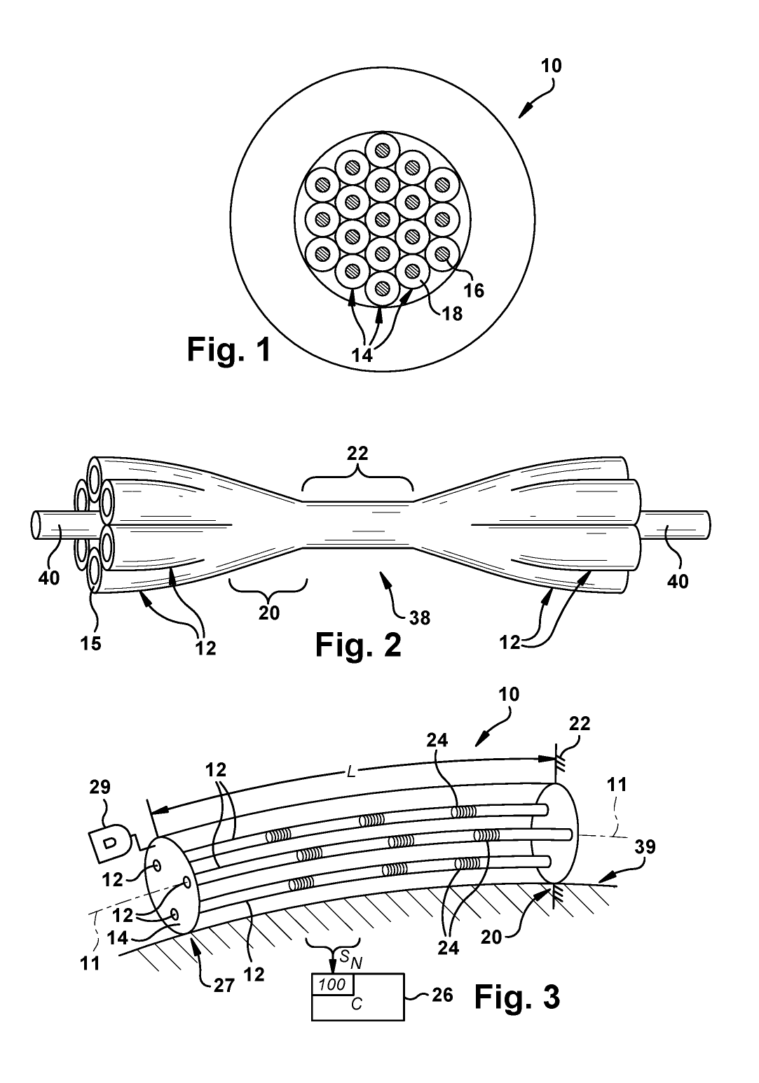

A glass optical fibre including multiple cores which are fused into a single fibre is explained in Patent No US006154594A, where the fused optical fibre is coherent. The cores maintain their relative position with respect to each other within the fibre throughout the length of the fibre. In one aspect of the disclosure, the fibre presents a circular cross section, in another it presents an elliptical cross section of greater eccentricity to ease the task of orienting the cores within the fibre for connection to signal sources, other fibres, integrated optic devices, receivers and other optical components (see FIG. 1).

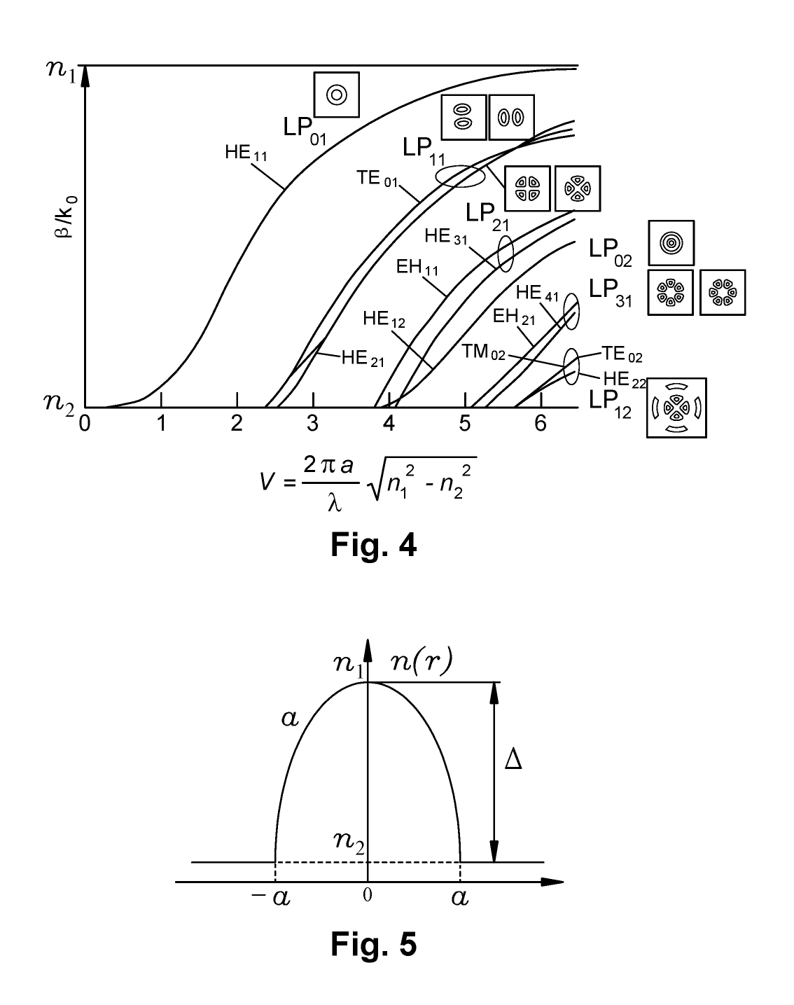

The combination of MCF and MMF is called Multi-Mode Multi-Core Fibres (MM-MCF) wherein multiple cores are incorporated within the same fibre cladding and each core allows multiple modes to be operated as separate channels in parallel. A well known issue in multi-mode operation of a fibre transmission link is differential mode delay (DMD), referred to those versed in the art, as dispersion, or the dispersive effects which lead to propagation time differences among the multiple modes of light. FIG. 4 explains phase characteristics of fibre modes versus normalized frequency.

DMD can be explained because a plurality of fiber modes, as may be excited by the 3-D Mode Multiplexing Chip, typically have differing group velocities, as their phase characteristics are different. Typically, each of the multiple modes propagating through the fibre core is not excited with a single data channel, but with a linear combination of data channels. And the modes usually exchange power among each other during transmission, which is described by those with an understanding of the art as crosstalk. It is important for these delay differences among the modes to be resolved for the purposes of combatting crosstalk effectively and thus ensuring data integrity.

The present disclosure overcomes the limitations that are attendant upon the propagation of multiple modes of light. Disclosed is a multi-core fibre transmission link, where each core guides multiple modes generated, for example by a 3-D Mode Multiplexing Chip. The disclosed embodiments can reduce DMD and increase the transmission capacity within a single fibre having comparatively small outer cladding diameter.

DMD in any multimode fibre leads to crosstalk, which will be removed or reduced in order to avoid the need for significant signal processing at the receiver end of the data transmission stream. Typically each of the modes of a multimode fibre is not excited with a single data channel, rather it takes a linear combination of data channels to excite every mode. Usually multiple modes exchange power among each other during transmission thereby causing crosstalk.

The system and method can include the use of multiple-input multiple-output (MIMO) signal processing at the receiving site. The MIMO signal processing is deployed to remove crosstalk and thus unravel the data channels. If the modes are not synchronized, the mode delay differences have to be resolved as well in MIMO signal processing at the receiving side, which makes crosstalk mitigation more difficult. DMD leads to increased complexity of the MIMO processing, as the crosstalk effects are smeared out over a longer range of data symbols, and thus compromise the system's performance.

The present disclosure provides for designing a multicore fibre in a way such that DMD in the various cores is controlled carefully. One way of achieving such fibre is by designing the index profile of each core. A careful design of a graded-index profile parameter (α) can tailor DMD's performance as shown in FIG. 5. A graded index profile is a refractive index profile which decreases gradually with increase in the radial distance from the optical axis of the core.

The disclosed systems and methods, in various embodiments, use an arrangement of multiple cores of multi-mode multi-core fibre or a multi-mode single-core fibre, in order to increase the transmission capacity, and to take full advantage of the data generation and transmission capability of the 3-D Mode Multiplexing Chip.

Phase characteristics of different fibre modes are plotted against normalized frequency V as shown in FIG. 4. The multi-mode regime is entered by operating at wavelength below cut-off wavelength of the fundamental LP₀₁ mode.

According to the graph (FIG. 4), to achieve multimode operation, the normalised frequency should be greater than 2.405 (V>2.405). When operating in the window of V>2.405 and V<3.83, a fibre core can guide not only the fundamental LP₀₁ mode, but also the LP₁₁ mode in its two degenerate states, namely the LP_{11A} and LP_{11B} mode fields. In addition, each of LP_{11A} and LP_{11B} mode can be operated in two orthogonal polarization states. This is thus titled Two-Mode Fibre (TMF) where six discrete transmission channels can be supported.

When V is increased beyond 3.83, the other higher-order modes come in, being subsequently the LP₂₁ mode with its degenerates, LP₀₂ mode, LP₃₁ mode, LP₁₂ mode, etc.

The main drawback in multi-mode operation of a fibre transmission link is differential mode delay (DMD), which is sometimes termed dispersion by those persons versed in the art. DMD leads to dispersion among the multiple modes in the fibre and thus the crosstalk effects emerging from cross-coupling between the modes are smeared out over long range transmission. As a result, overall performance of the system can be reduced substantially and can increase the complexity of the MIMO signal processing at the receiver side.

DMD can be controlled by designing the core index profile of a fibre as shown in FIG. 5. Here DMD between the LP₀₁ mode and the LP_{11A,B} modes of a TMF is considered. Within a relatively narrow wavelength range (V-range), the DMD can be reduced considerably. In order to disclose the full capacity per mode, wavelength multiplexing is needed and thus each mode must be operated over a wider wavelength range.

Moreover, a very small DMD along the whole length of the fibre link may not be optimum, as it implies that the LP₀₁ and LP₁₁ modes travel with nearly the same speed along the whole fibre link. Similar mode speeds create maximum non-linear interaction which results in decreased system performance.

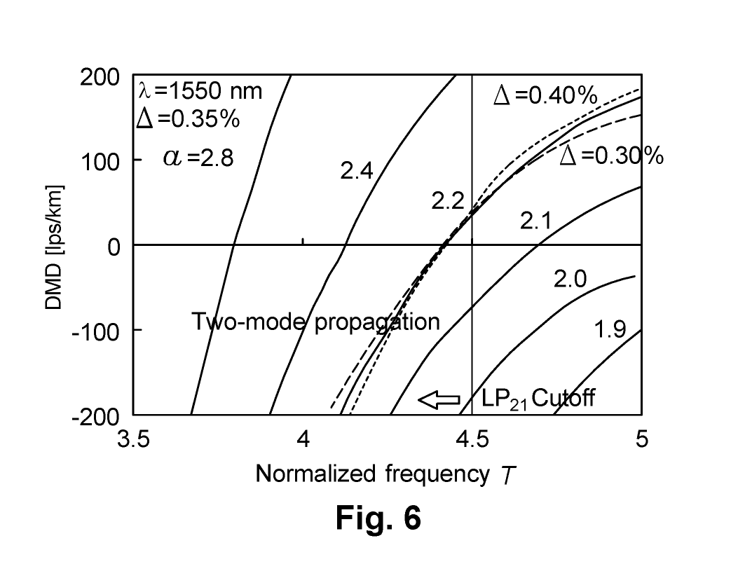

Local DMD differences along the fibre link can uncouple the speed similarities between two modes, say LP₀₁ and LP₁₁, thus reducing the non-linear interactions and improving system performance. FIG. 6 explains the characteristics of differential mode delay between the LP₀₁ and LP₁₁ modes for different index profile parameters.

In an embodiment of a multi-core fibre transmission link, each core guides multiple modes. Here the cores are designed in such a way that some of the cores show non-zero positive DMD, while other ones non-zero negative DMD in a certain wavelength range (V-range). This can be achieved by carefully designing the graded-index profile parameter a for each core, and the Multi-core Embodiment is illustrated in FIG. 6.

After transmission through a fibre section with positive DMD, transmission through a section with negative DMD can result in an accumulated DMD that is very small. Thus by alternating fibre sections with positive DMD, and then with negative DMD, the overall resulting DMD of the whole link will be very small. This results in desired amount of reduction in MIMO complexity and hence system performance increases.

In order to achieve this result, a multi-core fibre is proposed with one core, preferably in the centre, and an even number of outer cores with half of the cores having a positive DMD and the other half having an equally large negative DMD.

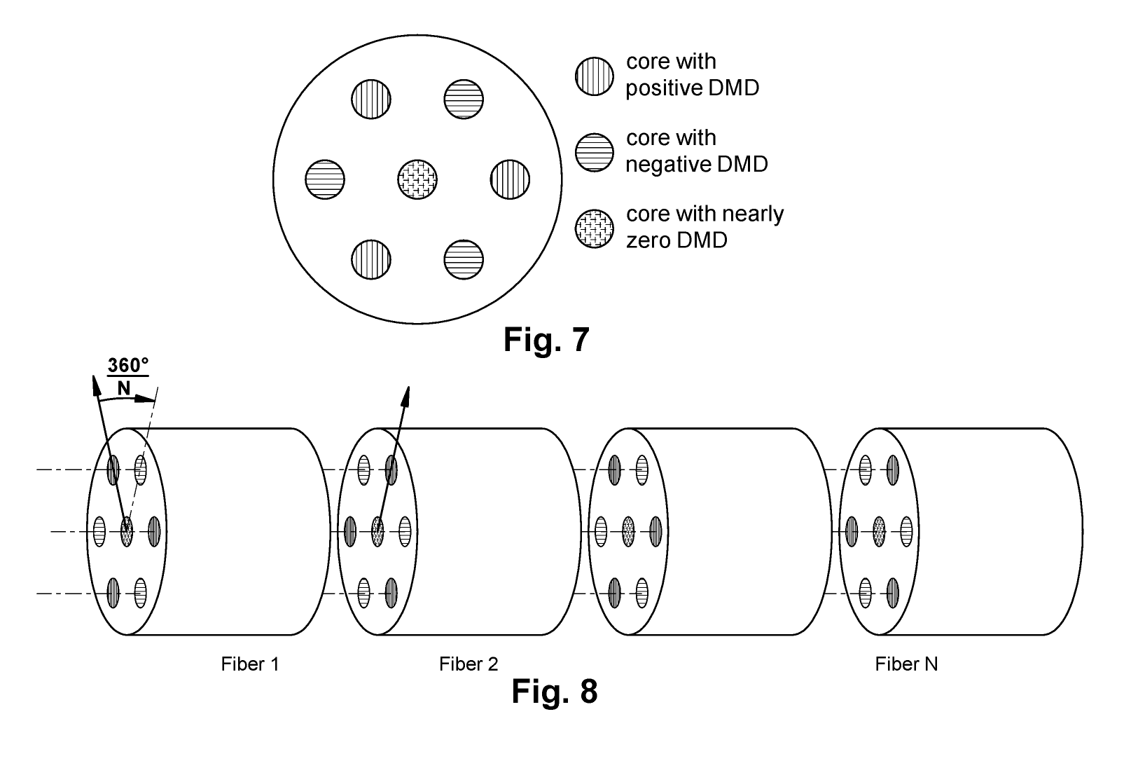

In accordance with this a multiple core fibre with 7 cores is shown in the FIG. 7. Number of outer cores, N=6, 3 cores out of 6 have positive DMD (cores with vertical lines) and the other 3 outer cores (cores with horizontal lines) have an equally-large negative DMD. The central core (core with hashes) may have a very small DMD (close to zero). It may be used for carrying lower-speed data streams, such as needed for management and control signals along the link.

The above mentioned design of multiple core fibre allows concatenation of MCF sections. By rotating the fibre joints with respect to each other by 360/N degrees, one section compensates the DMD of the previous one.

In the embodiment, positive DMD cores are connected to negative DMD ones and vice-versa. The overall end-to-end DMD of the whole concatenated fibre link can thus be very small, provided that the link installation is such that the MCF section lengths have approximately the same length. The procedure is explained with regard to FIG. 8.

In an embodiment, the concatenation of fibre sections with opposite DMD values may also be incorporated for a single-core fibre. In a single core fibre, both positive and negative DMD sections can be laid out to minimize the smear effects of two directional data transmission for more localized transmission of data.

In another embodiment, concatenation of fibre sections with opposite DMD values may also be incorporated for a two core fibre. In a two core fibre, both positive and negative DMD sections can be laid out to minimize the smear effects of two directional data transmission, such as may be needed in an office where both upload and download speeds are required to increase.

In accordance with embodiments of the present disclosure, a single optical fibre can be developed and manufactured with multiple multimode cores. These kinds of fibres are useful in the field of manufacturing efficiency and stock maintenance. The design of the manufactured fibre has cores laid out in a rotationally-symmetric topology with one core located in the center of the fibre, and N cores located evenly spread on a circle around the center, where N can be an even number.

In an embodiment of the present disclosure, an optical fibre may be developed and manufactured with a single multimode core. These kinds of fibres are useful in the field for distribution to office or high-end consumers.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A method, comprising:
alternating a first core portion with a second core portion to form an optical fiber having a plurality of alternating core portions,
wherein the first core portion has a positive differential mode delay over a range of wavelengths, and
wherein the second core portion has a negative differential mode delay over the range of wavelengths.

2. A system, comprising:
a multi-mode optical fiber configured for use over a range of wavelengths further comprising:
a first core portion having a positive differential mode delay over the range of wavelengths, and
a second core portion having a negative differential mode delay over the range of wavelength,
wherein the first core portion and the second core portion are configured in an alternating arrangement.
